(19) United States
(12) Patent Application Publication
(10) Pub. No.: US 2020/0175561 A1
(43) Pub. Date: Jun. 4, 2020

(54) SYSTEM AND METHODS FOR VERIFYING MERCHANTS TO INTERCHANGE NETWORKS

(71) Applicant: Mastercard International Incorporated, Purchase, NY (US)

(72) Inventors: Jerry Chit Leung, Lake St. Louis, MO (US); Kumar Balajii Rajappa, Kharadi (IN)

(73) Assignee: Mastercard International Incorporated, Purchase, NY (US)

(21) Appl. No.: 16/205,724

(22) Filed: Nov. 30, 2018

(51) Int. Cl. G06Q 30/06; G06Q 10/06

(52) U.S. Cl. CPC G06Q 30/0609; G06Q 10/067; G06Q 30/0613

(57) ABSTRACT

A merchant verification system and computer-implemented method for verifying and onboarding a merchant includes a memory device and a processor. The processor is programmed to receive an input file in a directory on the memory device. The input file includes entries including a merchant name and location information. The processor is programmed to generate an input load table from the input file. The processor is programmed to determine a transaction source type of the input load table based on a transaction source type code included in a custom set table and to append corresponding transaction source type data to the input load table to generate a match load table. The processor is also programmed to apply a plurality of business exception rules to each entry in the match load table to automatically verify and onboard at least one of the entries to the interchange network.

### FIELD OF THE DISCLOSURE

The field of the disclosure relates generally to systems and methods for verifying and onboarding merchants, and more particularly, to systems and methods for processing a client input file to automatically verify and onboard merchants to an interchange network.

### BACKGROUND OF THE DISCLOSURE

Acquirers, issuers, and/or other entities often include certain accounts associated with merchants that provide rebate services (e.g., programs, memberships, etc.) through which the merchants can receive rebates when consumers use payment accounts in general or use certain payment accounts to purchase products and/or services from the merchants. The acquirers, issuers, and/or the other associated entities compile lists of merchants attempting to subscribe to such rebate services and send the lists to interchange or payment networks requesting transaction data for the merchants for use in connection with the rebate services.

Typically, the interchange networks subject the merchant lists to one or more manual processes by which the merchants included in the lists are matched or verified according to merchant identifying information known to the interchange networks. For example, at least some known manual processes include manually creating temporary files for each included merchant and for each of authorization data and clearing data. The authorization and clearing data for each included merchant is then manually searched based on merchant location and added to the respective merchant temporary file. The temporary files also often include action codes, which are updated manually as the process progresses to indicate the state of the verification of the merchants as data is again manually added to and/or removed from the temporary files and other files associated with verified and/or un-verified merchants. Such processes result in loading of the merchant correlations to the interchange network, whereby the requested transaction data will be directed to the requesting acquirer, issuer, or third-party aggregator.

### BRIEF DESCRIPTION OF THE DISCLOSURE

This summary is not intended to identify essential features of the present disclosure and is not intended to be used to limit the scope of the claims. These and other aspects of the present disclosure are described below in greater detail.

In one aspect, a merchant verification system for verifying and onboarding a merchant received from a third-party aggregator to an interchange network is provided. The merchant verification system includes a memory device for storing data and a processor communicatively coupled to the memory device. The processor is programmed to receive an input file in a directory defined in the memory device. The input file includes one or more entries, each entry including a merchant name and merchant location information. The processor is programmed to generate an input load table from the input file. The input load table contains the one or more entries. The input load table is temporarily stored in the memory device. The processor is also programmed to determine a transaction source type of the input load table based on a transaction source type code included in a custom set table, and based on the determined transaction source type, append corresponding transaction source type data to the input load table to generate a match load table. Furthermore, the processor is programmed to apply a plurality of business exception rules to each entry of the one or more entries included in the match load table to automatically verify and onboard at least one of the one or more entries to the interchange network.

In another aspect, a computer-implemented method for verifying and onboarding a merchant received from a third-party aggregator to an interchange network is provided. The method includes monitoring a directory defined on a memory device and receiving an input file in the directory. The input file includes one or more entries including a merchant name and location information. The method also includes generating an input load table from the input file, the input load table containing the one or more entries and temporarily storing the input load table in the memory device. Furthermore, the method includes determining a transaction source type of the input load table based on a transaction source type code included in a custom set table, and based on the determined transaction source type, generating a match load table by appending corresponding transaction source type data to the input load table. Moreover, the method includes automatically verifying and onboarding at least one of the one or more entries to the interchange network by applying a plurality of business exception rules to each entry of the one or more entries included in the match load table.

In yet another aspect, a computer-implemented method for refreshing location data associated with merchants received from a third-party aggregator is provided. The merchants are verified to an interchange network. The method includes retrieving a custom set merchant table from a memory device associated with the interchange network. The custom set merchant table includes one or more entries. Each of the entries includes interchange network merchant location data contained therein. The method also includes determining a refresh frequency from a custom set table and determining a refresh type from the custom set table. Furthermore, the method includes, based on the determined refresh frequency and refresh type, performing one or more refresh operations on the custom set merchant table to identify updated merchant location data. Moreover, the method includes generating a custom set input file from the custom set merchant table and the updated merchant location data.

### BRIEF DESCRIPTION OF THE DRAWINGS

Embodiments of the present invention are described in detail below with reference to the attached drawing figures, wherein:

FIG. 1 is a block diagram of an example multi-party payment card network system having a merchant verification module;

FIG. 2 is a simplified block diagram of an example transaction processing system (TPS) for for verifying merchant information using the merchant verification module shown in FIG. 1;

FIG. 3 is an expanded block diagram of an example embodiment of a server architecture of a payment processing system;

FIG. 4 is an example configuration of a user system operated by a user, such as a cardholder of the multi-party payment card network system shown in FIG. 1;

FIG. 5 is an example configuration of a server system, such as a server system for use in the system shown in FIG. 2;

FIG. 6 is a schematic diagram of a data flow through the merchant verification module shown in FIG. 1, and is association with a client file;

FIGS. 7A-7B illustrate a flow chart of an example method for verifying merchants using the merchant verification module shown in FIG. 1;

FIG. 8 is a schematic diagram of a data flow through merchant verification module shown in FIG. 1, and in association with refreshing merchant location data in a custom set merchant table; and

FIG. 9 is a flow chart of an example method for refreshing the location data associated with merchants shown in FIG. 1 and contained in the custom set merchant table of FIG. 8.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized and changes may be made without departing from the scope of the claims. The following description is, therefore, not limiting. It is contemplated that the disclosure has general application to verifying and onboarding merchants received from third-party aggregators. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, implementations of the present disclosure can include a variety of combinations and/or integrations of the embodiments described herein.

Broadly characterized, the present disclosure relates to a system for verifying and onboarding merchants received from a third-party aggregator. As an example, for the third-party aggregator (or an interchange network) to provide rebates to merchants, or to acquirers or others associated with purchase transactions performed by cardholders, specific transaction data from issuers is needed to verify the transactions and associated rebates. The third-party aggregators (which may, for example, be associated with acquirers or issuers, etc.) compile files or lists of qualified merchants to onboard the merchants to the rebate services at the interchange network. The third-party aggregators provide client files including the identified merchants to the interchange network. The interchange network processes the client files to automatically verify and onboard the identified merchants. In particular, as part of the verification process, the interchange network uses the client files to identify the merchants by a merchant location identifier (ID). The interchange network then appends transaction data, including authorization data, clearing data, and other location data for the identified merchants based on the appended merchant location IDs. The transaction data is verified and the client file data is modified, as necessary, to further include merchant IDs and acquiring Interbank Card Associations (ICA) numbers for each of the merchant entries included in the client file. The client files are then transmitted back to the clients for use in correlating later received transaction data for the various identified merchants to tabulate or otherwise calculate rebates, etc. Although the onboarding/verification process is particularly useful with rebate programs, aspects of the present disclosure are equally applicable to other network programs and/or applications.

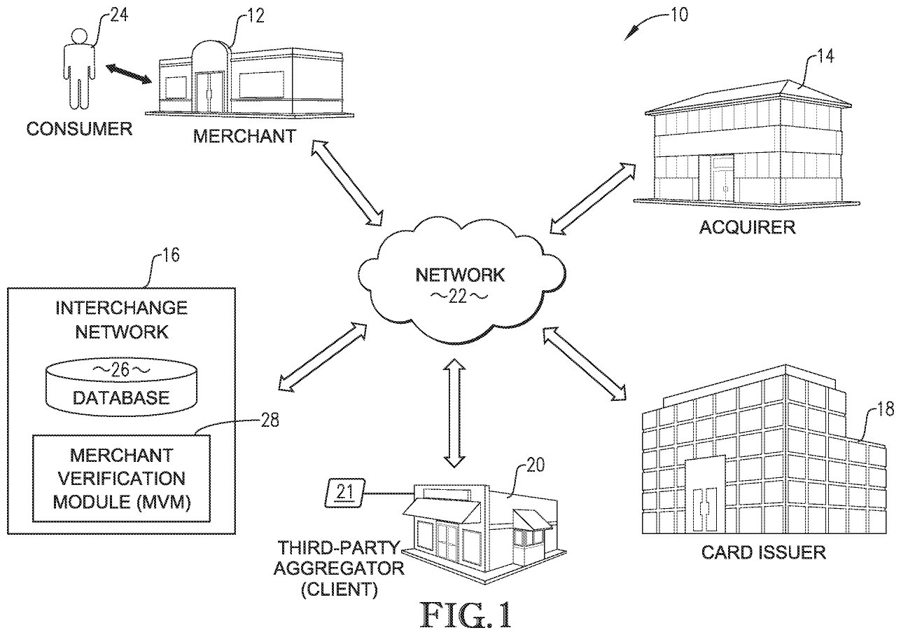

FIG. 1 is a block diagram of an example multi-party payment card network system 10 having a merchant verification module (MVM) 28 (broadly, a merchant verification system). The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

In the example embodiment, the payment card network system 10 generally includes the merchants 12, the acquirers 14, the interchange network 16, the issuers 18, and third-party aggregators 20 (broadly, clients) coupled in communication via a network 22. The network 22 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, the issuers 18, and/or the third-party aggregators 20. In some embodiments, the network 22 may include more than one type of network, such as a private payment transaction network provided by the interchange network 16 to the acquirers 14, the issuers 18, and/or the third-party aggregators 20, and, separately, the public Internet, which may facilitate communication between the merchants 12, the interchange network 16, the acquirers 14, and the consumers 24, etc. While the third-party aggregator 20 is illustrated as a stand-alone part in FIG. 1, it should be appreciated that the third-party aggregator 20 may be associated with (or incorporated into) other parts of the payment card network system 10 in other embodiments (e.g., the acquirer 14, the issuer 18, etc.).

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 24, who uses the transaction card to tender payment for a purchase from the merchant 12. In the example embodiment, the merchant 12 is typically associated with products, for example, and without limitation, goods and/or services, that are offered for sale and are sold to the consumers 24. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 24 provides payment for a purchase with a transaction card, the merchant 12 requests authorization from the acquirer 14 for the purchase amount. The request may be performed over the telephone, but is usually performed using a point-of-sale terminal that reads the cardholder's account information from a magnetic stripe, a chip, or embossed characters on the transaction card and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 24 cancels a transaction before it is captured, a “void” is generated. If the cardholder 24 returns goods after the transaction has been captured, a “credit” is generated. The interchange network 16 and/or the issuer 18 stores the transaction data, such as, and without limitation, payment account number (PAN), a type of merchant, a merchant identifier, a location where the transaction was completed, an amount of purchase, a merchant category code, a date and time of the transaction, products purchased and related descriptions or identifiers, etc., in a transaction database 26.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data and stored within the transaction database 26, at the merchant 12, the acquirer 14, the payment network 16, and/or the issuer 18. Further, transaction data, unrelated to a particular payment account, may be collected by a variety of techniques, and similarly stored within the transaction database 26.

In some embodiments, cardholders 24 involved in the transactions described herein are prompted to agree to legal terms associated with their payment accounts, for example, during enrollment in such payment accounts, etc. As such, the cardholder 24 may voluntarily agree to allow the merchants 12, the issuers 18, the interchange network 16, etc., to utilize data collected during enrollment and/or collected relating to processing the transactions, subsequently for one or more of the purposes described herein.

Furthermore, the interchange network 16 includes the MVM 28 that is configured to analyze various data associated with the payment card transactions and provide various information to one or more parties involved in the payment card transaction, such as the third-party aggregator 20 (e.g., the acquirer 14, the issuer 18, etc.). Specifically, the MVM 28 is a specially programmed computer system that enables the interchange network 16 to implement an automated process to receive a client input file 21 including a list of merchants 12 to associate a location identifier with each of the merchants 12, for example, that have opted to take advantage of a service offered by the third-party aggregator 20, such as a rebate service. After receiving the client input file 21, the MVM 28 associates a location identifier with each of the merchants 12 included in the client input file 21, i.e., for each merchant entry. Upon appending the location identifier or ID to the client input file 21 for each merchant entry, the MVM 28 is configured to, for each merchant 12 in the file (or each merchant entry), retrieve transaction data based on the location ID for the merchant 12, and append it to a file for the merchant 12. Based on the transaction data, additional merchant entries may be included in the client input file 21, for example, for merchants 12 at a same location, but having different merchant IDs.

While only one merchant 12, acquirer 14, interchange network 16, and issuer 18 are shown in FIG. 1 (for ease of reference), it should be appreciated that a variety of other embodiments may include multiple ones of these parts in various combinations.

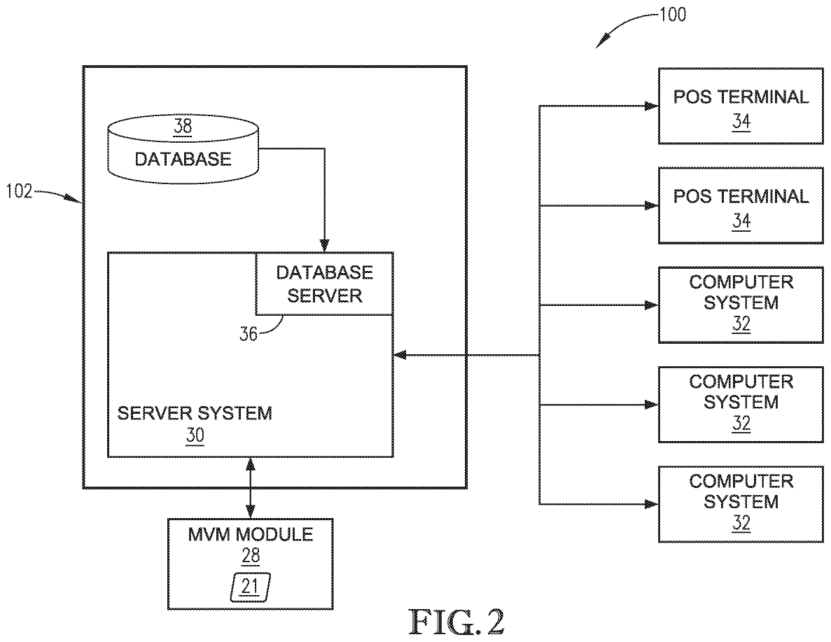

FIG. 2 is a simplified block diagram of an example transaction processing system (TPS) 102 for verifying merchant information using the MVM. The TPS 102 provides transaction data for verified merchants using the MVM 28 to the third-party aggregator 20 (e.g., acquirers 14, issuers 18, etc.) in the payment network 100. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the TPS 102 in communication with a point-of-sale (POS) terminal 34 at a merchant 12 location (shown in FIG. 1), and/or other client systems 32 associated with merchants, merchant banks, payment networks, issuer banks, and/or the third-party aggregator 20.

More specifically, in the example embodiment, the TPS 102 includes the server system 30 of, for example, the interchange network 16 (shown in FIG. 1), in communication with the POS terminal 34 and the client systems 32 associated with merchants, merchant banks, payment networks, issuer banks, and/or the third-party aggregator 20. The server system 30 is also in communication with a plurality of client sub-systems, also referred to as the client systems 32. In one embodiment, the client systems 32 are computers including a web browser, such that server system 30 is accessible to the client systems 32 using the Internet. The client systems 32 are interconnected to the Internet through one or more of many interfaces including, for example, a network, such as a LAN or WAN, dial-in-connections, cable modems, and/or special high-speed Integrated Services Digital Network (ISDN) lines. The client systems 32 could be any device capable of interconnecting to the Internet including an Internet connected phone, a PDA, or any other suitable web-based connectable equipment.

In the example embodiment, the TPS 102 also includes one or more POS terminals 34, which may be connected to the client systems 32 and may be connected to the server system 30. The POS terminals 34 may be interconnected to the Internet (or any other network that allows the POS terminals 34 to communicate as described herein) through many interfaces including a network, such as a local area network (LAN) or a wide area network (WAN), dial-in-connections, cable modems, wireless modems, and special high-speed ISDN lines. The POS terminals 34 are any device capable of interconnecting to the Internet and including an input device capable of reading information from a cardholder's financial transaction card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the merchant identification data as described below in greater detail. In one embodiment, the database 38 is a centralized database stored on the server system 30 and can be accessed by potential users at one of the client systems 32 by logging onto the server system 30 through one of the client systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account data including at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data. The database 38 may also store digital wallet data, device information, payment card information, and other data involved with verifying merchants 12 and providing transaction data for the verified merchants to, for example, the third-party aggregator 20.

In the example embodiment, one of the client systems 32 may be associated with the acquirer 14 and/or the third-party aggregator 20 (shown in FIG. 1) while another one of the client systems 32 may be associated with the issuer 18 (shown in FIG. 1). The POS terminal 34 may be associated with the merchant 12 (shown in FIG. 1) or may be a computer system and/or mobile system used by a cardholder making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the client systems 32 and the POS terminals 34 may include a computer system associated with at least one of a merchant, an online bank, a bill payment outsourcer, an acquirer bank, an acquirer processor, an issuer bank associated with a transaction card, an issuer processor, a remote payment processing system, a third-party aggregator, and/or a biller.

In the example embodiment, the TPS 102 is in communication with the MVM 28, which may be associated with the interchange network 16 or with an outside third party in a contractual relationship with the interchange network 16. In the example embodiment, the MVM 28 analyzes transaction data and provides various information to one or more parties involved in the payment card transaction, such as the third-party aggregator 20. Specifically, the MVM 28 associates a location identifier with each of the merchants 12 included in the client input file 21. Upon appending the location identifier or ID to the client input file 21 for each merchant entry, the MVM 28 is configured to, for each merchant 12 in the file (or each merchant entry), retrieve transaction data based on the location ID for the merchant 12, and append it to a file for the merchant 12. In some embodiments, the MVM 28 is also in communication with the third-party aggregator 20, a merchant system, an issuer system (e.g., the client systems 32), and/or the POS terminals 34 of the merchant 12. It is noted that the payment network 100 may include more, fewer, or alternative components and/or perform more, fewer, or alternative actions, including those discussed elsewhere herein.

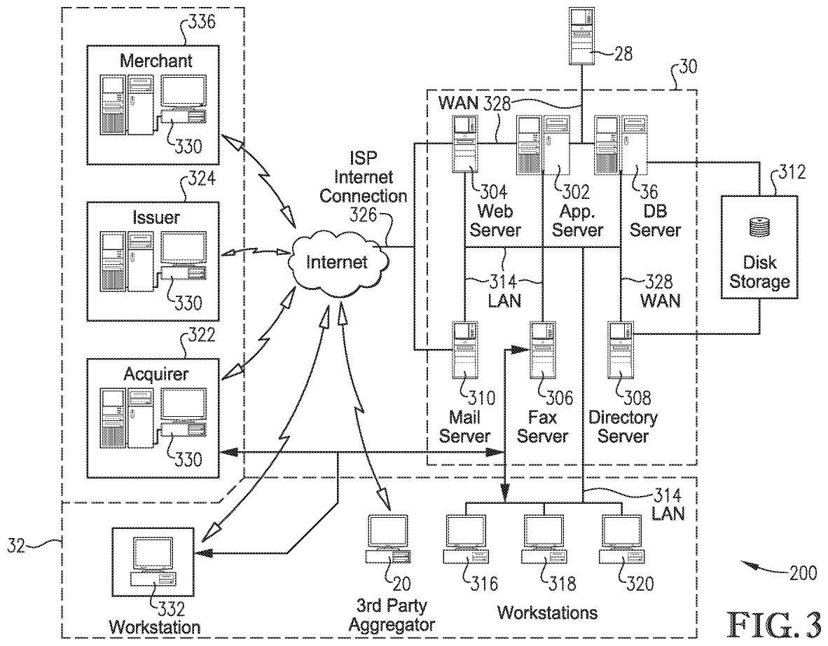

FIG. 3 is an expanded block diagram of an example embodiment of a server architecture of payment processing system 200 in accordance with one embodiment of the present disclosure. Payment processing system 200 includes the server system 30, the MVM 28, and the client systems 32. The server system 30 further includes the database server 36, an application server 302, a web server 304, a fax server 306, a directory server 308, and a mail server 310. A disk storage unit 312 is coupled to database server 36 and directory server 308. The servers 36, 302, 304, 306, 308, and 310 are coupled in communication in a local area network (LAN) 314. In addition, a system administrator's workstation 316, a user workstation 318, and a supervisor's workstation 320 are coupled to the LAN 314. Alternatively, the workstations 316, 318, and 320 are coupled to the LAN 314 using an Internet link or are connected through an Intranet.

In the example embodiment, each of the workstations 316, 318, and 320 is a personal computer having a web browser. Although the functions performed at the workstations typically are illustrated as being performed at respective workstations 316, 318, and 320, such functions can be performed at one of many personal computers coupled to the LAN 314. The workstations 316, 318, and 320 are illustrated as being associated with separate functions only to facilitate an understanding of the different types of functions that can be performed by individuals having access to the LAN 314.

The server system 30 and the MVM 28 are configured to be communicatively coupled to various entities, including acquirers 322 and issuers 324, and to third parties, e.g., the third-party aggregator 20, using an Internet connection 326. The server system 30 is also communicatively coupled with one or more merchants 336. The communication in the example embodiment is illustrated as being performed using the Internet, however, any other wide area network (WAN) 328 type communication can be utilized in other embodiments, i.e., the systems and processes are not limited to being practiced using the Internet. In addition, and rather than the WAN 328, the LAN 314 could be used in place of the WAN 328.

In the example embodiment, any authorized individual or entity having a workstation 330 may access the payment processing system 200. At least one of the client systems 32 includes a manager workstation 332 located at a remote location. The workstations 330 and 332 include personal computers having a web browser. Also, the workstations 330 and 332 are configured to communicate with the server system 30 and the MVM 28. Furthermore, the fax server 306 communicates with remotely located client systems, including the client system 332, using a telephone link. The fax server 306 is configured to communicate with other client systems 316, 318, and 320 as well.

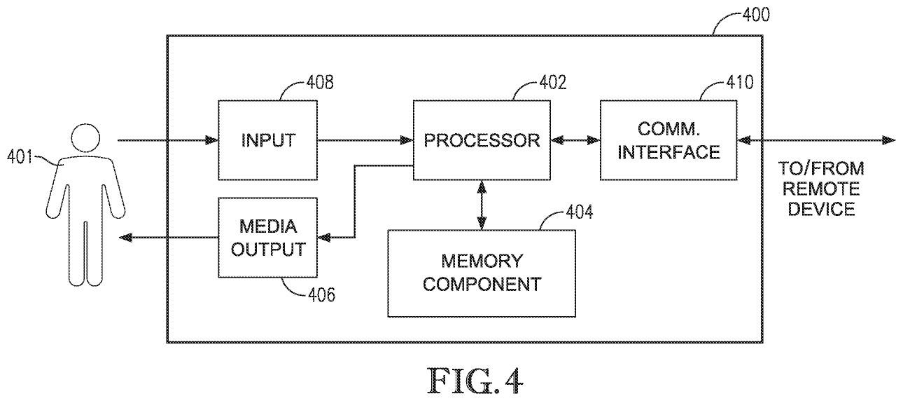

FIG. 4 is an example configuration of a user system 400 operated by a user 401, such as the cardholder 24 (shown in FIG. 1). In some embodiments, the user system 400 is a client system 32 and/or a merchant POS terminal 34. In the example embodiment, the user system 400 includes a processor 402 for executing instructions. In some embodiments, executable instructions are stored in a memory device 404. The processor 402 includes one or more processing units, for example, a multi-core configuration. The memory device 404 is any device allowing information such as executable instructions and/or written works to be stored and retrieved. The memory device 404 includes one or more computer readable media.

The user system 400 also includes at least one media output component 406 for presenting information to the user 401. The media output component 406 is any component capable of conveying information to the user 401. In some embodiments, the media output component 406 includes an output adapter such as a video adapter and/or an audio adapter. An output adapter is operatively coupled to the processor 402 and operatively connectable to an output device such as a display device, for example, and without limitation, a liquid crystal display (LCD), organic light emitting diode (OLED) display, or “electronic ink” display, or an audio output device such as a speaker or headphones.

In some embodiments, the user system 400 includes an input device 408 for receiving input from the user 401. The input device 408 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 406 and the input device 408. The user system 400 may also include a communication interface 410, which is communicatively connectable to a remote device such as the server system 30, the client systems 32, and/or the POS terminals 34 (shown in FIG. 2). The communication interface 410 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 404 are, for example, computer readable instructions for providing a user interface to the user 401 via the media output component 406 and, optionally, receiving and processing input from the input device 408. A user interface may include, among other possibilities, a web browser and a client application. Web browsers enable users, such as the user 401, to display and interact with media and other information typically embedded on a web page or a website from the server system 30. A client application allows the user 401 to interact with a server application associated with a merchant.

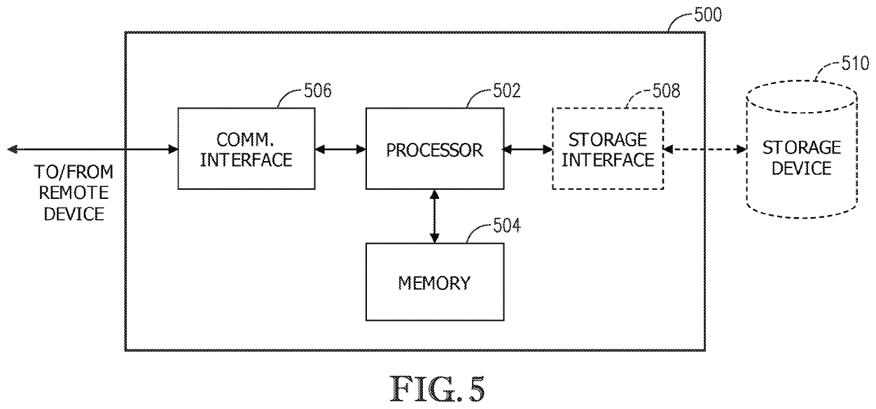

FIG. 5 is an example configuration of a server system 500, such as the server system 30 (shown in FIG. 2). The server system 500 includes, but is not limited to, the transaction database 26 (shown in FIG. 1) and the MVM 28 (shown in FIG. 1). In the example embodiment, the server system 500 includes a processor 502 for executing instructions. The instructions may be stored in a memory area 504, for example. The processor 502 includes one or more processing units (e.g., in a multi-core configuration) for executing the instructions. The instructions may be executed within a variety of different operating systems on the server system 500, such as UNIX, LINUX, Microsoft Windows®, etc. More specifically, the instructions may cause various data manipulations on data stored in a storage device 510 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 502 is operatively coupled to a communication interface 506 such that the server system 500 can communicate with a remote device such as a user system 400 (shown in FIG. 4) or another server system 500. For example, the communication interface 506 may receive communications from a client system 32 via the Internet, as illustrated in FIG. 2.

The processor 502 is operatively coupled to the storage device 510. The storage device 510 is any computer-operated hardware suitable for storing and/or retrieving data. In some embodiments, the storage device 510 is integrated in the server system 500. In other embodiments, the storage device 510 is external to the server system 500 and is similar to the transaction database 26. For example, the server system 500 may include one or more hard disk drives as the storage device 510. In other embodiments, the storage device 510 is external to the server system 500 and may be accessed by a plurality of server systems 500. For example, the storage device 510 may include multiple storage units such as hard disks or solid-state disks in a redundant array of inexpensive disks (RAID) configuration. The storage device 510 may include a storage area network (SAN) and/or a network attached storage (NAS) system.

In some embodiments, the processor 502 is operatively coupled to the storage device 510 via a storage interface 508. The storage interface 508 is any component capable of providing the processor 502 with access to the storage device 510. The storage interface 508 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 502 with access to the storage device 510.

The memory area 504 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

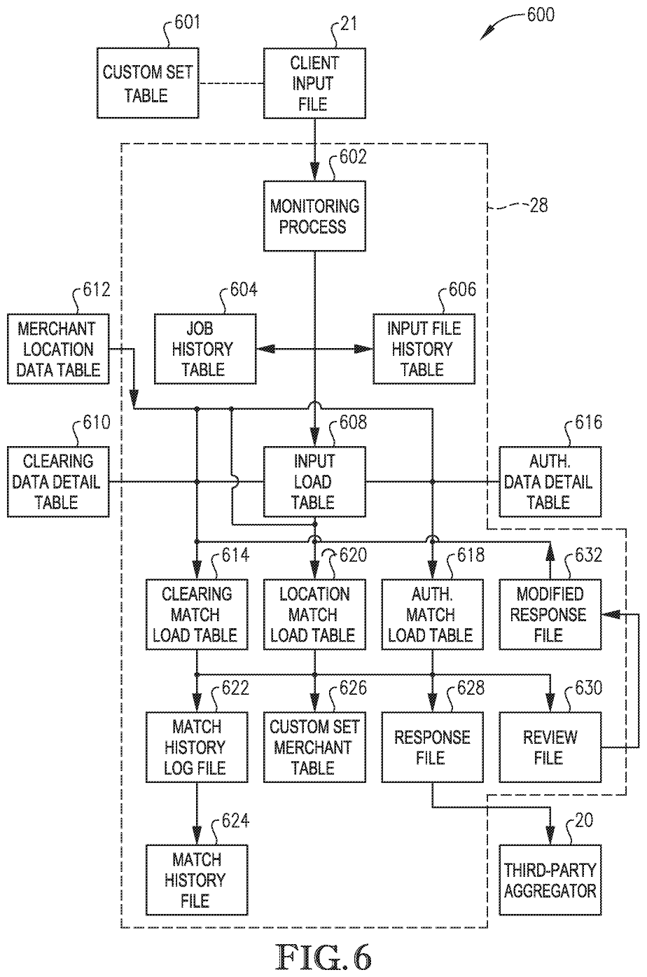

FIG. 6 is a schematic diagram of data flow 600 through MVM 28 in association with the client input file 21. In the exemplary embodiment, the interchange network 16 (shown in FIG. 1) may offer a service for verifying merchants 12 (shown in FIG. 1) identified, for example, by the third-party aggregator 20 (e.g., an acquirer 14, etc.) (shown in FIG. 1) as participating in a program offered by the the third-party aggregator 20, such as a rebate program. The program may require that the participating merchants process and/or clear transactions associated with consumer payment accounts. The third-party aggregator 20 may provide to the interchange network 16 the client input file 21, which identifies merchants 12 opting to take advantage of the program (e.g., a rebate service).

The MVM 28 includes a predefined custom set table 601 including various information and/or settings for a set of merchants. In addition, the MVM 28 includes a file monitoring component 602 configured to monitor a predefined file input directory, for example, on the server system 30 (shown in FIG. 2) to identify specific files, such as the client input file 21. The monitoring component 602 generates a job history record 604, an input file history record 606, and an input load table 608 from the received client input file 21. The input load table 608 may be a temporary staging table stored, for example, in the memory area 504 (shown in FIG. 5) of the server system 500 (shown in FIG. 5).

In one embodiment, the input load table 608 may be merged with transaction clearing data from a clearing data detail table 610 and location data from a merchant location data table 612. The clearing data detail table 610 and merchant location data table 612 may be stored, for example, as part of the transaction data stored in the database 38 (shown in FIG. 2) of the server system 30. The merged data may be temporarily stored in the memory area 504, for example, as a clearing match load table 614.

In another embodiment, the input load table 608 may be merged with transaction authorization data from an authorization data detail table 616 and the location data from the merchant location data table 612. The authorization data detail table 616 and merchant location data table 612 may be stored, for example, as part of the transaction data stored in the database 38 of the server system 30. The merged data may be temporarily stored in the memory area 504, for example, as an authorization match load table 618.

Furthermore, in another suitable embodiment, the input load table 608 may be merged the location data from the merchant location data table 612. The merged data may be temporarily stored in the memory area 504, for example, as a location match load table 620.

The clearing match load table 614, authorization match load table 618, and location match load table 620 may be merged into a match history log table 622. The match history log table 622 may be stored, for example, in the database 38 of the server system 30, and includes, for example, all the original data from the input load table 608 and all associated clearing, authorization, and location data for each merchant entry in the input load table 608. The match history log table 622 is associated with a match history table 624.

Furthermore, the clearing match load table 614, authorization match load table 618, and location match load table 620 may be merged into a custom set merchant table 626. The MVM 28 merges only records from the clearing match load table 614, authorization match load table 618, and location match load table 620 with process flag=Y to facilitate onboarding a merchant 12 identified in the client input file 21.

In the exemplary embodiment, one or more of the clearing match load table 614, authorization match load table 618, and location match load table 620 may be utilized and/or merged together into a response file 628 and a review file 630. The response file 628 includes appended transaction data (e.g., clearing, authorization, and/or location) along with the original input values from the client input file 21. The response file 628 may be provided to the third-party aggregator 20 (or other external customer) indicating the completion of the merchant verification or onboarding process. The client may then utilize the appended location information to facilitate matching future transaction data for verified (i.e., onboarded) merchants 12. The review file 630 includes, for example, the same information as the response file 628 with the addition of several additional data fields that may be utilized for review purposes. Users can utilize the review file 630 to make any necessary modifications to each record and resubmit the file to the MVM 28 as a modified response file 632.

It should be noted that in one embodiment, the MVM 28 executes all tasks sequentially. In alternative embodiments, the MVM 28 includes a capability to process some tasks in parallel. This “parallel processing” is accomplished using separate threads for each parallel task and waiting for all tasks to complete prior to continuing. For example, and without limitation, in one embodiment, the MVM 28 may process five separate input files in parallel. The MVM 28 also provides an ability to gracefully shutdown. As is well known in the art, to accomplish a graceful shutdown, all threads should complete their work and the MVM 28 should not start processing any new input files. When all threads have completed their processing, the MVM 28 ends the processing.

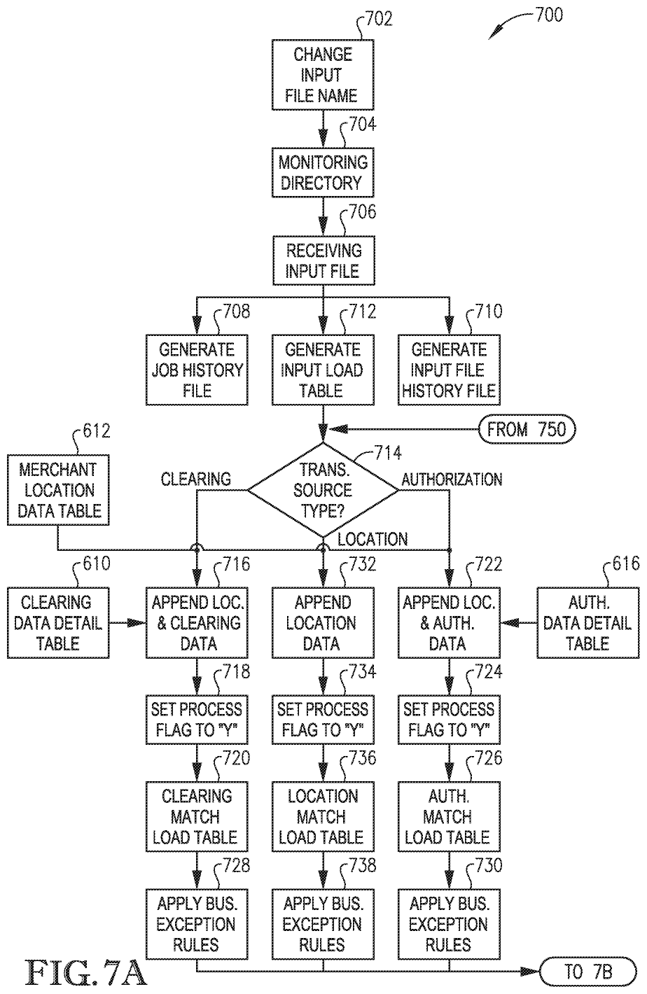

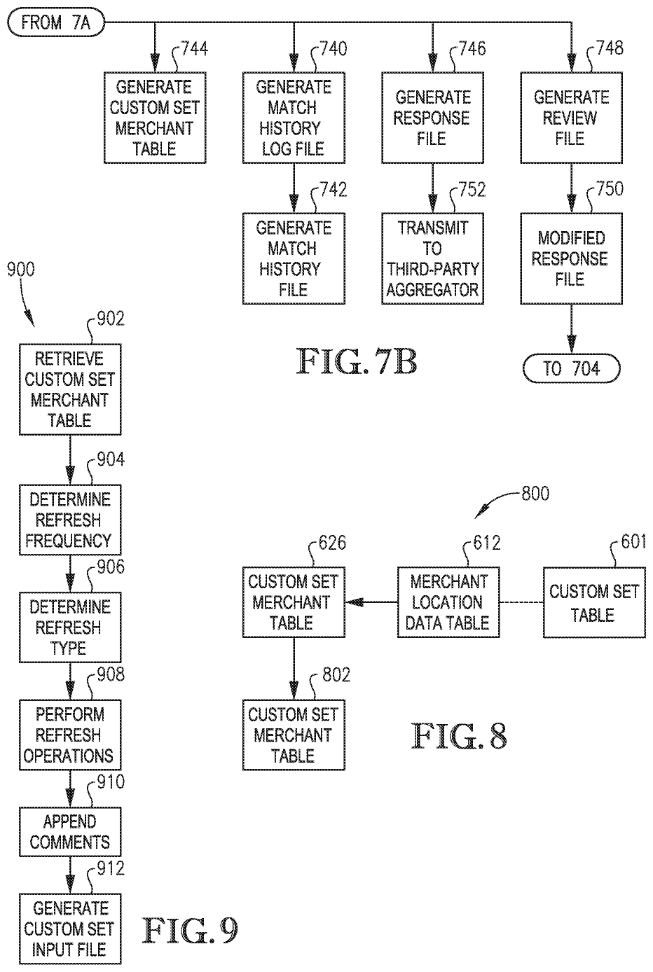

FIGS. 7A and 7B illustrate a flow chart of an example method 700 for verifying a merchant or merchants 12 (shown in FIG. 1). In the example embodiment, the method 700 is implemented by the MVM 28 (shown in FIG. 1). The method 700 is a computer-implemented method for associating a location identifier (ID) (corresponding to a location identifier of the interchange network 16 (shown in FIG. 1)) with each of the merchants 12 included in the client input file 21 (shown in FIG. 1), retrieving transaction data based on the location ID for the merchant 12, and appending the transaction data to the response file 628 (shown in FIG. 6). The third-party aggregator 20 provides a client input file 21 that includes the aggregation of merchants 12 that elect to participate in one or more programs and/or services offered by the third-party aggregator 20 (e.g., the acquirer 14, the interchange network 16, and/or the issuer 18). In the exemplary embodiment, the program involves rebates (e.g., discounts, refunds, commissions, fees, paybacks, payments, etc.) that are paid to the merchants 12 based on transactions (and related transaction data) processed by the merchants 12.

In the exemplary embodiment, at operation 702, an input file name of an input file, such as the client input file 21, is changed to a standard format. For example, and without limitation, in one embodiment, the input file name will be converted to a format including PREFIX+SET NAME (SET_NAM)+“.csv”. In one suitable embodiment, the PREFIX is “MAS_INPUT”. To set the name, the file name is used without a transaction source suffix and all spaces are replaced with an underscore character. For example, a file name of “TLP STARBUCKS CLR” is converted to “TLP_STARBUCKS”. The file name is then appended with the suffix “.csv”.

In some embodiments, the input file includes the modified response file 632 (shown in FIG. 6). The modified response file 632 may be converted into the format “PREFIX+ANYTHING+SUFFIX+“.csv”. For example, and without limitation, the PREFIX is “MAS_RESPONSE”. The “ANYTHING” portion can include any characters; however, spaces are converted to underscores. The SUFFIX includes the transaction source code. For example, if the file is a clearing data file, the SUFFIX is “CLR”, and if the file is an authorization data file, the SUFFIX is “AUTH”. The file name is then appended with the suffix “.csv”. In embodiments where the input file is the modified response file 632, the method proceeds directly to operation 714 below.

At operation 704, the method 700 includes monitoring a predefined directory to detect insertion of the input file. At operation 706, the method includes receiving the input file, e.g., the client input file 21. Alternatively, in embodiments where the input file is the modified response file 632, the method proceeds directly to operation 714 below.

In the exemplary embodiment, the client input file 21 includes, for example, one or more merchants 12 opting to participate in a program and/or service offered by the third-party aggregator 20, e.g., a rebate service. The third-party aggregator 20 compiles the client input file 21 in which an entry is created for each of the participating merchants 12. The third-party aggregator 20 often has only limited information for the merchants 12, and thus, appends the limited information to the client input file 21. The merchant information included in the client input file 21 typically includes the merchant's name and address (e.g., street number and name, city, state, postal code, country, etc. (i.e., the merchant's physical location information)).

In some embodiments, the client input file 21 includes a merchant identifier (or merchant ID) for each merchant entry. The client input file 21 may be provided according to a format specified by the interchange network 16, i.e., a standard format. For example, a format may include an entry for each of the included merchants 12 in a different row, with columns in a particular order, such that the MVM 28 (of the interchange network 16) is able to recognize specific information such as the postal code, for example, based on the column in which it is populated. For each cell within the client input file 21 (in which the format includes a table) that is blank, the MVM 28 will understand the information to be missing or omitted. In at least one embodiment, the format of the client input file 21 may be non-standard, for which the MVM 28 identifies content of the files based on column headers, for example. Periodically, the third-party aggregator 20 transmits the client input file 21 to the interchange network 16, which is understood as a request to verify or onboard the merchants 12 included in the client file, for example, in connection with the program and/or service offered by the interchange network 16, etc. In addition, the client file may include merchants 12 that should be removed from the program or service.

At operation 708, the method 700 includes generating the job history record 604 (shown in FIG. 6), and at operation 710, the method 700 includes generating the input file history records 606 (shown in FIG. 6). In one example embodiment, the job history record 604 and the input file history record 606 may be stored in the database 38 of the server system 30 (shown in FIG. 2). At operation 712, the method 700 includes generating the input load table 608, for example, by aligning all merchant owned card link service (CLS) related table names with the prefix “CLS_”. The input load table 608 includes the merchant entries or records in the input file and may be loaded and temporarily stored in the database 38 of the server system 30.

At operation 714, the MVM 28 determines the transaction source type of the input file, i.e., the input load table 608, based on the transaction source type code (TRAN_SRC_CD) variable value contained in the custom set table 601. Based on the transaction source type, the MVM 28 processes the input load table 608 through the appropriate processes, for example, CLEARING, AUTHORIZATION, or LOCATION.

If the transaction source type is CLEARING, at operation 716, the MVM 28 appends the input load table 608 with location data from the merchant location data table 612 and clearing transaction data from the clearing data detail table 610. After appending the location and clearing transaction data to the input load table 608, the MVM 28 sets a process flag for each entry to “Y” at operation 718, thereby indicating each entry should processed. A process flag of “Y” indicates that the entry should be processed by the MVM 28. At operation 720, the MVM 28 generates the clearing match load table 614, which includes the appended location and clearing transaction data with each entry having a process flag of “Y.”

Likewise, if the transaction source type is AUTHORIZATION, at operation 722, the MVM 28 appends the input load table 608 with location data from the merchant location data table 612 and authorization transaction data from the authorization data detail table 616. After appending the location and authorization transaction data to the input load table 608, the MVM 28 sets a process flag for each entry to “Y” at operation 724, thereby indicating each entry should processed. At operation 726, the MVM 28 generates the authorization match load table 618, which includes the appended location and authorization transaction data with each entry having a process flag of “Y.”

At operations 728 and 730, the MVM 28 applies a plurality of business exception rules to each data entry of the clearing match load table 614 and the authorization match load table 618, respectively. For example, and without limitation, the MVM 28 checks an action code of each entry in the load tables 614 and 618 to see if it is a valid action code. If the action code is not “M,” “D,” “K,” “V,” “Q,” “J,” “N.” “X,” or “R,” the MVM 28 appends a comment to the entry indicating “Invalid Action Code.” In addition, the MVM 28 changes the process flag for the entry to “N,” which indicates that the entry should not be processed. The Actions codes described above are included in the table below for reference.

| Action Code | Detail |
|---|---|
| M | Matched new location to be added |
| V | Verified and Matched new location to be added |
| K | Change request to existing location |
| D | End date existing location |
| Q | Questionable location |
| J | Junk location to be excluded/End date an excluded |
| | location |
| N | No Match/No action required |
| X | Bad record to be excluded from CLS_MATCH_HIST |
| | table and modified RESPONSE file |
| R | False positive location through refresh process and |
| | should be omitted from any history tables or any |
| | outgoing files |

If the action code is “Q,” the MVM 28 appends a comment to the entry indicating “Questionable Action Code.” In addition, the MVM 28 changes the process flag for the entry to “N.” Furthermore, if the action code is “J,” “N,” or “X,” the MVM 28 changes the process flag for the entry to “N.” In one embodiment, if the action code is “D,” and a merchant location removal date of the entry is NULL, the MVM 28 changes the process flag for the entry to “N” and appends a comment to the entry indicating “Missing Removal Date.”

If the input file (i.e., the load table 614 or 618) is the client input file 21, the onboard type is semi-automated or manual, and the action code is “M” or “V” and primary keys set ID (SET_ID), location ID (LOC_ID), acquirer merchant ID (ACQ_MERCH_ID), and chain ID (CHAIN_ID) already exist in the custom set merchant table 626 (e.g., if the input file has been processed in the past), the MVM 28 changes the process flag for the entry to “N” and appends a comment to the entry indicating “Already Onboarded.” Further, if the input file is the modified response file 632, the onboard type is automated, and the action code is “M” or “V” and primary keys SET_ID, LOC_ID, begin date (BGN_DT), ACQ_MERCH_ID, and CHAIN_ID already exist in the custom set merchant table 626 (e.g., if the input file has been processed in the past), the MVM 28 changes the process flag for the entry to “N” and appends a comment to the entry indicating “Existing Record.”

If the action code is “V,” the MVM 28 sets the process flag for the entry to “Y” and appends a comment to the entry indicating “Verified Record.” This process may be required when the input file is, for example, the modified response file 632 and the process flag may have been set to “N”.

In one embodiment, if the action code is “K” or “D” and the primary keys SET_ID, LOC_ID, BGN_DT, ACQ_MERCH_ID, and CHAIN_ID do not exist in the custom set merchant table 626, the MVM 28 changes the process flag for the entry to “N” and appends a comment to the entry indicating “Non-existing Record.”

Furthermore, in one example, if the variable Mastercard acquirer merchant ID (MC_ACQ_MERCH_ID) is NULL, the variable transaction source type code (TRAN_SRC_CD) is not L (location based), the action code is “M,” “V,” “K,” or “‘D,” and the variable Mastercard location ID (MC_LOC_ID) is not NULL, the MVM 28 sets the process flag to “N” and appends a comment to the entry indicating “No Merch ID.” In another embodiment, if the primary key MC_LOC_ID is NULL, the MVM 28 sets the process flag to “N” and appends a comment to the entry indicating “Missing Location ID.” Moreover, in some embodiments, if the action code is NULL, the MVM 28 changes the process flag for the entry to “N” and appends a comment to the entry indicating “Missing Action Code.”

In some embodiments, the third-party aggregator 20 may not wish to onboard or verify a payment facilitator. In such an instance, if input file is the client input file 21, the variable payment facilitator switch (PAYMENT_FACILITATOR_SW) is set to “N,” the variable service provider hierarchy payment facilitator switch (SVC_PROVIDER_HIERARCHY.PAYMT_FAC_SW) is set to “Y,” and the action code is “M,” or “V,” the MVM 28 changes the process flag for the entry to “N” and appends a comment to the entry indicating “Payment Facilitator.”

In some suitable embodiments, if action code is “J” and the primary keys SET_ID, MC_LOC_ID, merchant site ID (MERCH_SITE_ID), MC_ACQ_MERCH_ID, and Mastercard acquirer interbank card association number (MC_ACQ_ICA_NUM) do not exist in a data exclusion table (not shown), the MVM 28 inserts the data into the data exclusion table. Further, if the action code is “J” and the primary keys SET_ID, MC_LOC_ID, MERCH_SITE_ID, MC_ACQ_MERCH_ID, MC_ACQ_ICA_NUM already exist in the data exclusion table, the MVM 28 updates the variable card link service data exclusion end date (CLS_DATA_EXCLUSION.END_DT) with the system date when the variable end date (END_DT) is NULL or sets the primary keys CLS_DATA_EXCLUSION.END_DT to NULL when primary key END_DT is not NULL. Moreover, if the action code is “J,” the MVM 28 changes the process flag for the entry to “N” and appends a comment to the entry indicating “Junk Record.”

In an alternative embodiment, a business exception rule includes determining whether the input file type is the client input file 21, the onboard type is semi-automated or manual, and multiple entries (or records) have the same value in primary keys SET_ID, MC_LOC_ID, BGN_DT, MC_ACQ_MERCH_ID, and Mastercard acquirer interbank card association (MC_ACQ_ICA) with the same action code but a different transaction name, the MVM 28 changes the process flag for the entry to “N” and appends a comment to the entry indicating “Multi-TRANS_NAM.” This indicates that the same location is included in the input file but has multiple transaction names.

Furthermore, in some embodiments, if multiple entries (or records) include the same value in the primary keys SET_ID, MC_LOC_ID, BGN_DT, MC_ACQ_MERCH_ID, and MC_ACQ_ICA, but different values in the primary keys MERCH_SITE_ID or client pass through fields (CLNT_PASS_THRGH_1 through CLNT_PASS_THRGH_4), the MVM 28 changes the process flag for the entry to “N” and appends a comment to the entry indicating “Multi-Site ID or CLNT_PASS_THRGH Fields.”

Moreover, if multiple entries (or records) include the same value in the primary keys SET_ID, MC_LOC_ID, BGN_DT, MC_ACQ_MERCH_ID, and MC_ACQ_ICA with a first action code “D” and a second action code of “M” or “V,” the MVM 28 changes the process flag for the entry to “N” and appends a comment to the entry indicating “K Recommended.”

Additionally, if the input file is the client input file 21, the onboard type is manual, and the process flag is “Y,” the MVM 28 changes the process flag for the entry to “N.”

In some embodiments, if the comment field includes more than one comment (separated by a comma, for example) and one of the comments begins with “Refreshed,” the MVM 28 sets the action code to “R.” Further, if the input file is the client input file 21 and the comment field includes “Refreshed,” the MVM 28 changes the process flag for the entry to “N.”

Furthermore, the MVM 28 may recover any missing or deleted entries from the input file history record 606 based on the job ID (JOB_ID) and having an action code other than “X.” In addition, the MVM 28 may recover any missing or deleted entries from the input file history record 606 based on the JOB_ID and having an action code of “X” only if the entry is the only remaining MERCH_SITE_ID variable representation in the clearing match load table 614 or authorization match load table 618. The MVM 28 appends a comment to the recovered record indicating “Recovered from Original.”

In the exemplary embodiment, if the transaction source type is LOCATION, at operation 732, the MVM 28 appends the input load table 608 with location data from the merchant location data table 612. After appending the location data to the input load table 608, the MVM 28 sets a process flag for each entry to “Y” at operation 734, thereby indicating each entry should processed. At operation 736, the MVM 28 generates the location match load table 620, which includes the appended location data with each entry having a process flag of “Y.”

At operation 738, the MVM 28 applies a plurality of business exception rules to each data entry of the location match load table 620. The business exception rules are similar to the business exception rules for the CLEARING and AUTHORIZATION process branches of the method 700. For example, and without limitation, the MVM 28 checks an action code of each entry in the location match load table 622 to see if it is a valid action code. If the action code is not “M,” “D,” “K,” “V,” “Q,” “J,” “N.” “X,” or “R,” the MVM 28 appends a comment to the entry indicating “Invalid Action Code.” In addition, the MVM 28 changes the process flag for the entry to “N.” As used herein, a process flag of “N” indicates that the corresponding entry should not be further processed.

If the action code is “Q,” the MVM 28 appends a comment to the entry indicating “Questionable Action Code.” In addition, the MVM 28 changes the process flag for the entry to “N.” Furthermore, if the action code is “J,” “N,” or “X,” the MVM 28 changes the process flag for the entry to “N.” In one embodiment, if the action code is “D,” and a merchant location removal date of the entry is NULL, the MVM 28 changes the process flag for the entry to “N” and appends a comment to the entry indicating “Missing Removal Data.”

If the input file (i.e., the location match load table 622) is the client input file 21, the onboard type is semi-automated or manual, and the action code is “M” or “V” and primary keys SET_ID and LOC_ID already exist in the custom set merchant table 626 (e.g., if the input file has been processed in the past), the MVM 28 changes the process flag for the entry to “N” and appends a comment to the entry indicating “Already Onboarded.” Further, if the input file is the modified response file 632, the onboard type is automated, and the action code is “M” or “V” and primary keys SET_ID, LOC_ID, and BGN_DT already exist in the custom set merchant table 626 (e.g., if the input file has been processed in the past), the MVM 28 changes the process flag for the entry to “N” and appends a comment to the entry indicating “Existing Record.”

If the action code is “V,” the MVM 28 sets the process flag for the entry to “Y” and appends a comment to the entry indicating “Verified Record.” This process may be required when the input file is, for example, the modified response file 632 and the process flag may have been set to “N”.

In one embodiment, if the action code is “K” or “D” and the primary keys SET_ID, LOC_ID, and BGN_DT do not exist in the custom set merchant table 626, the MVM 28 changes the process flag for the entry to “N” and appends a comment to the entry indicating “Non-existing Record.”

Moreover, in some embodiments, if the action code is NULL, the MVM 28 changes the process flag for the entry to “N” and appends a comment to the entry indicating “Missing Action Code.”

In some suitable embodiments, if action code is “J” and primary keys SET_ID, MC_LOC_ID, and MERCH_SITE_ID do not exist in a data exclusion table (not shown), the MVM 28 inserts the data into the data exclusion table. Further, if the action code is “J” and the primary keys SET_ID, MC_LOC_ID, and MERCH_SITE_ID already exist in the data exclusion table, the MVM 28 updates the primary key CLS_DATA_EXCLUSION.END_DT with the system date when the primary key END_DT is NULL or sets the primary key CLS_DATA_EXCLUSION.END_DT to NULL when primary key END_DT is not NULL. Moreover, if the action code is “J,” the MVM 28 changes the process flag for the entry to “N” and appends a comment to the entry indicating “Junk Record.”

In an alternative embodiment, if multiple entries (or records) include the same value in the primary keys SET_ID, MC_LOC_ID, and BGN_DT, but different values in the primary keys MERCH_SITE_ID or CLNT_PASS_THRGH_1 through CLNT_PASS_THRGH_4, the MVM 28 changes the process flag for the entry to “N” and appends a comment to the entry indicating “Multi-Site ID or CLNT_PASS_THRGH Fields.”

Moreover, if multiple entries (or records) include the same value in the primary keys SET_ID, MC_LOC_ID, and BGN_DT with a first action code “D” and a second action code of “M” or “V,” the MVM 28 changes the process flag for the entry to “N” and appends a comment to the entry indicating “K Recommended.”

Additionally, if the input file is the client input file 21, the onboard type is manual, and the process flag is “Y,” the MVM 28 changes the process flag for the entry to “N.”

In some embodiments, if the comment field includes more than one comment (separated by a comma, for example) and one of the comments begins with “Refreshed,” the MVM 28 sets the action code to “R.” Further, if the input file is the client input file 21 and the comment field includes “Refreshed,” the MVM 28 changes the process flag for the entry to “N.”

Furthermore, the MVM 28 may recover any missing or deleted entries from the input file history record 606 based on the the JOB_ID and having an action code other than “X.” In addition, the MVM 28 may recover any missing or deleted entries from the input file history record 606 based on the the JOB_ID and having an action code of “X” only if the entry is the only remaining MERCH_SITE_ID variable representation in the clearing match load table 614 or authorization match load table 618. The MVM 28 appends a comment to the recovered record indicating “Recovered from Original.”

In the exemplary embodiment, at operation 740, the MVM 28 generates the match history log table 622 by merging each of the clearing match load table 614, the authorization match load table 618, and/or the location match load table 620. It is noted that the input file (e.g., the client input file 21) may not undergo each of the CLEARING, AUTHORIZATION, and/or LOCATION processes, as indicated at operations 716, 722, and 732, respectively. However, any tables generated by any of the processes for the input file are merged to generate the match history log table 622. In addition, at operation 742, any entry with an action code of “J,” “X,” or “R” may be deleted or otherwise removed from the match history log table 622 to generate the match history table 624. In the exemplary embodiment, a user of, for example, the user workstation 318 may manually review or otherwise refer to the match history table 624 for purposes described herein. However, if the user chooses to remove a record or entry before resubmitting a file for processing by applying an action code of “X,” the user may not wish to see the record any longer when reviewing the match history table 624. As such, the match history table 624 only maintains the history of the input file excluding the records or entries removed manually be the user. The match history log table 622 maintains the entire history of the input file processing.

At operation 744, the method 700 includes generating the custom set merchant table 626 by merging all entries or records having a process flag of “Y” from any of the clearing match load table 614, the authorization match load table 618, and/or the location match load table 620. The custom set merchant table 626 may be stored, for example, and without limitation, in the database 38 of the server system 30. In the example embodiment, the custom set merchant table 626 may be utilized by the interchange network 16 to provide requested transaction data to the third-party aggregator 20.

Furthermore, at operation 746, the method 700 includes generating the response file 628. The response file 628 may also be referred to as the outgoing response file, since it is the file transmitted back to the third-party aggregator 20. The outgoing response file 628 contains the appended data from the interchange network 16 along with the original input values received in the client input file 21. The response file 628 may be stored, for example, and without limitation, in the database 38 of the server system 30. As described above, the response file 628 may be provided to the third-party aggregator 20 indicating the completion of the merchant verification and onboarding process. The third-party aggregator 20 may then utilize the appended location information to match future transaction data to enrolled merchants.

At operation 748, the method 700 includes generating the review file 630. The review file 630 may be stored, for example, and without limitation, in the database 38 of the server system 30. The review file 630 may be manually reviewed to address any errors in the entries or to address the comments appended by the MVM 28, as described above during processing of the business exception rules. The review file 630 contains all the standard response file fields plus the following additional fields for review purposes:

| | |
|---|---|
| LOAD_DT | Date record loaded |
| UPDT_DT | Not in use |
| END_DT | Not in use |
| MC_MERCH_TRAN_NAM | Transaction merchant name |
| | appended from transaction |
| | detail tables |
| PROCESS_FLAG_SW | indication of record being |
| | merged into the custom set |
| | merchant table |
| SET_ID | Unique ID for each Custom Set |
| JOB_ID | Unique ID created when an |
| | incoming INPUT file submitted |

The users may utilize the review file 630 to make any necessary modifications to each entry or record based on the comment text field value populated through business exception rule process.

At operation 750, the method 700 includes generating the modified response file 632. The modified response file 632 may be used as the input file to the method 700 for reprocessing of the entries after being modified by the user, as described above. The modified response file 750 may be referred to as the incoming response file and will not require transaction data to be appended. Therefore, transaction data will not be staged in input load table 608 as described above. Rather, after generating the input load table 608, the business exception rules for the appropriate process path will be applied.

In such an embodiment, if the modified response file 632 is used as the input file for reprocessing, the response file 746 may be deleted. After processing of the modified response file 632, a new response file 628 is generated. The method 700 is therefore iterative and continues so long as a user generates a modified response file 632 from the review file 630 and submits it back into the method 700.

At operation 752, the MVM 28 may transmit the processed client input file, i.e., the response file 628 to the third-party aggregator 20. In turn, the third-party aggregator 20 may use the response file 628 consistent with the description herein, for example, to map and/or correlate transaction data (based on merchant IDs and/or interbank card association numbers (ICAs) in the response file 628), including later received transaction data, to calculate or otherwise determine rebates owed to currently and/or previously onboarded merchants 12.

In this manner, investigation of merchants by merchant identifier and/or location, and potentially the combination of merchants by a merchant identifier and/or location provides efficiencies in verification of the merchants. In particular, the placement of client files in particular directories cause the automated gathering of transaction data for the merchants listed in the client files, based on the merchant location, generally without user intervention, whereby the user resources may be allocated elsewhere. As such, the systems and methods herein provide efficiencies to the verification of merchants, which result in greater throughput for merchant verification for a given user resource.

FIG. 8 is a schematic diagram of data flow 800 through MVM 28 in association with refreshing (broadly, updating) merchant location data in the custom set merchant table 626 (shown in FIG. 6). In the exemplary embodiment, the interchange network 16 (shown in FIG. 1) may offer a service for updating the location data of merchants 12 (shown in FIG. 1) identified, for example, by the third-party aggregator 20 (e.g., an acquirer 14, etc.) (shown in FIG. 1) as participating in a program offered by the the third-party aggregator 20, such as a rebate program.

In the exemplary embodiment, the MVM 28 includes the custom set table 601 and the custom set merchant table 626 as described above. The custom set merchant table 626 may be stored, for example, on the server system 30 (shown in FIG. 2) and includes one or more entries or records corresponding to one or more merchants 12 participating in the third-party aggregator's program. The custom set merchant table 626 is associated with the merchant location data table 612, which may be stored in the database 38 on the server system 30. The merchant location data table 612 includes location data for merchants that are associated with the interchange network 16, including for example, mapping an old location for a merchant to the merchant's new location, mapping an old merchant ID to the merchant's new merchant ID, mapping a new merchant that is associated with a merchant aggregate set, etc. A custom set input file 802 is generated from the custom set merchant table 626 after updating the merchant location data from the merchant location data table 612, based on update frequency settings in the custom set table 601.

FIG. 9 is a flow chart of an example method 900 for refreshing (broadly updating) the location data associated with merchants 12 (shown in FIG. 1) contained in the custom set merchant table 626 (shown in FIG. 6). In the example embodiment, the method 900 is implemented by the MVM 28 (shown in FIG. 1). The method 900 is a computer-implemented method for associating new and/or additional location identifiers (IDs) (corresponding to location identifiers of the interchange network 16 (shown in FIG. 1)) with each of the merchants 12 included in the custom set merchant table 626. Locations of merchants 12 within the custom set merchant table 626 may be required to be refreshed and/or updated to keep the location data fresh. The method 900, or refresh process identifies any new locations or stale locations required to be onboarded or end-dated, respectively. Once a new or additional location is identified, the method 900 generates the custom set input file 802 (shown in FIG. 8) to be submitted to the method 700 (shown in FIGS. 7A-7B) described above.

In the exemplary embodiment, the third-party aggregator 20 specifies the frequency with which the merchant location data is to be refreshed for the merchants 12 that elect to participate in one or more programs and/or services offered by the third-party aggregator 20 (e.g., the acquirer 14, the interchange network 16, and/or the issuer 18). In the exemplary embodiment, the program involves rebates (e.g., discounts, refunds, commissions, fees, paybacks, payments, etc.) that are paid to the merchants 12 based on transactions (and related transaction data) processed by the merchants 12. The frequency may include, for example, and without limitation, weekly, monthly, quarterly, or yearly. It is noted that the refresh schedule may include other periods than those described above.

At operation 902, the method 900 includes retrieving the custom set merchant table 626 from, for example, the database 38 of the server system 30. In particular, the MVM 28 may retrieve one or more custom set merchant tables 626 corresponding to one or more third-party aggregators 20 from the database 38. At operation 904, the method 900 includes determining the refresh frequency or update schedule from the custom set table 601 associated with the custom set merchant table 626. For example, the custom set table 601 may include a refresh frequency code variable, such as the variable refresh frequency code (RFRSH_FREQ_CD). The refresh frequency code may include, for example, the following values: Null=manual refresh; W=Weekly; M=Monthly; Q=Quarterly; and Y=Yearly. In the example embodiment, the monthly refresh frequency corresponds to the 15th of every month of the year, the quarterly refresh frequency corresponds to the 15th of January, April, July, and October of a respective year, and the yearly refresh frequency corresponds to the 15th of each January. A Null value indicates that the refreshing or updating of the merchant locations should be performed manually. The operation of determining the refresh frequency includes, for example, performing an identification operation to obtain a list of SET_IDs (corresponding to the custom set merchant tables 626) that are due for the refresh process in the following week based on their refresh frequency.

At operation 906, the method 900 further includes determining a refresh type to be performed by the MVM 28 from the custom set table 601. For example, the custom set table 601 may include a refresh type code variable that may include, for example, one of the following refresh types: Rolled Location, New Merchant ID, Stale Location, New Aggregate Location, and New M.I.A. Matching Location.

The rolled location refresh type may include, for example, identifying a new or changed merchant location ID for a merchant 12 that is included in the custom set merchant table 626. For example, some existing merchant location IDs may roll under a newly identified merchant location ID or vice versa. When this occurs, the onboarded merchant location ID may no longer be active and may require new location IDs to be identified. There are several types of rolled location IDs the rolled location process may identify. For example, when an existing active location ID becomes an old location ID and it is rolled under a new location ID, this may be referred to as being rolled forward. When a new location ID is rolled under an existing active location ID, this may be referred to as rolled backward. A semi-aggressively rolled location ID may include, for example, a manual process where two location IDs may not be automatically matched and mapped into the merchant location data table 612, but because of various transaction data, may be manually matched.

The new merchant ID refresh type may include, for example, identifying when a merchant, such as the merchant 12, changes its acquirer or when its acquirer assigns a new acquirer merchant ID to the merchant. In such an instance, the existing acquirer merchant ID will no longer be valid and must be matched to the new acquirer merchant ID.

The stale location refresh type may include, for example, identifying merchants, via the merchant location ID, that have not had any transaction activity with a predetermined period. For example, and without limitation, for a CLEARING transaction source type of the client file, as described above, the process may determine the difference between the system date and the last clearing transaction date within the merchant location data table 612. If the period exceeds a predefined threshold, the location may be marked as stale and flagged for removal from the custom set merchant table 626. Likewise, for an AUTHORIZATION transaction source type of the client file, as described above, the process may determine the difference between the system date and the last transaction authorization date within the merchant location data table 612. If the period exceeds a predefine threshold, the location may be marked as stale and flagged for removal from the custom set merchant table 626. Moreover, for a LOCATION transaction source type of the client file, as described above, the process may determine the difference between the system date and the change date within the merchant location data table 612. If the period exceeds a predefined threshold, the location may be marked as stale and flagged for removal from the custom set merchant table 626.

The new aggregate location refresh type may include, for example, identifying new merchant locations, via the aggregate merchant ID, that are part of an aggregate group of merchants. For example, the third-party aggregator 20 may use the new aggregate location process to identify new locations that are aggregated under the same aggregate merchant ID within existing countries in a merchant set.

The new M.I.A matching location refresh type may include, for example, identifying new merchant locations related to an existing merchant location ID in the custom set merchant table 626. For example, some new merchant location IDs created may not be identified to roll with an existing merchant location ID. Therefore, it may not be identified through the rolled location process. The new M.I.A matching location process generates a new M.I.A matching file based on all active location from the original client input file 21 records stored within the input file history record 606 (shown in FIG. 6).

In some embodiments, a notification may be sent to, for example, the user of the user workstation 318 and/or a distribution group of users. The notification may include, for example, the list of set IDs, the refresh frequency of each customer set merchant table 626, and the refresh type that is to be performed by the MVM 28.

At operation 908, the method 900 further includes performing one or more refresh or updating processes based on the refresh frequency or update schedule and the refresh type, as identified in the custom set table 601. For example, and without limitation, the custom set merchant table 626 is compared to the merchant location data table 612 to identify updated location information. The location data table 612 includes location data for merchants that are associated with the interchange network 16, including for example, mapping an old location for a merchant to the merchant's new location, mapping an old merchant ID to the merchant's new merchant ID, mapping a new merchant that is associated with a merchant aggregate set, etc.

At operation 910, the method 900 also includes appending a comment to the entries of the custom set merchant table 626 indicating, for example, that the entries were refreshed, and by what refresh type. For example, and without limitation, a comment for a rolled location refresh type may indicated, “Refresh—Rolled Location.”

At operation 912, the method 900 includes generating the custom set input file 802 (shown in FIG. 8) from the custom set merchant table 626 after updating the merchant location data from the merchant location data table 612 using one or more refresh types. The custom set input file 802 may then be input back into the method for verifying merchants 12, described above with respect to the method 700.

Any actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A merchant verification system for verifying and onboarding a merchant received from a third-party aggregator to an interchange network, said merchant verification system comprising:
a memory device for storing data; and
a processor communicatively coupled to said memory device, said processor programmed to:
receive an input file in a directory defined in said memory device, the input file including one or more entries, each entry including a merchant name and merchant location information;
generate an input load table from the input file, the input load table containing the one or more entries, the input load table temporarily stored in said memory device;
determine a transaction source type of the input load table based on a transaction source type code included in a custom set table;
based on the determined transaction source type, append corresponding transaction source type data to the input load table to generate a match load table; and
apply a plurality of business exception rules to each entry of the one or more entries included in the match load table to automatically verify and onboard at least one of the one or more entries to the interchange network.

2. The merchant verification system in accordance with claim 1,
said processor further programmed to set a process flag for each entry of the one or more entries in the match load table to indicate whether each entry is to be processed.

3. The merchant verification system in accordance with claim 2,
wherein applying a plurality of business exception rules to each entry comprises setting the process flag for at least one of the entries to indicate that the at least one of the entries should not be further processed.

4. The merchant verification system in accordance with claim 3,
said processor programmed to generate a custom set merchant table from the match load table, the custom set merchant table including only entries of the one or more entries having the process flag set to indicate that each entry is to be processed.

5. The merchant verification system in accordance with claim 3,
said processor programmed to:
determine a refresh frequency from the custom set table;
determine a refresh type from the custom set table; and
based on the determined refresh frequency and refresh type, perform one or more refresh operations on the custom set merchant table to identify updated merchant location data.

6. The merchant verification system in accordance with claim 1,
said processor programmed to generate a job history record from the input file.

7. The merchant verification system in accordance with claim 1,
said processor programmed to generate an input file history record from the input file.

8. The merchant verification system in accordance with claim 1,
said processor programmed to generate a match history log record from the match load table.

9. The merchant verification system in accordance with claim 1,
said processor programmed generate a response file from the match load table, the response file including the one or more entries of the input file and the appended corresponding transaction source type data.

10. A computer-implemented method for verifying and onboarding a merchant received from a third-party aggregator to an interchange network, said method comprising:
monitoring a directory defined on a memory device;
receiving an input file in the directory, the input file including one or more entries including a merchant name and location information;
generating an input load table from the input file, the input load table containing the one or more entries;
temporarily storing the input load table in the memory device;
determining a transaction source type of the input load table based on a transaction source type code included in a custom set table;
based on the determined transaction source type, generating a match load table by appending corresponding transaction source type data to the input load table; and
automatically verifying and onboarding at least one of the one or more entries to the interchange network by applying a plurality of business exception rules to each entry of the one or more entries included in the match load table.

11. The method in accordance with claim 10, further comprising:
setting a process flag for each entry of the one or more entries in the match load table to indicate whether each entry is to be processed.

12. The method in accordance with claim 11, wherein applying the plurality of business exception rules to each entry comprises setting the process flag for at least one of the entries to indicate that the at least one of the entries should not be further processed, said method comprising:
generating a custom set merchant table from the match load table, the custom set merchant table including only entries of the one or more entries having the process flag set to indicate that each entry is to be processed.

13. The method in accordance with claim 10, further comprising:
determining a refresh frequency from the custom set table;
determining a refresh type from the custom set table; and
based on the determined refresh frequency and refresh type, perform one or more refresh operations on the custom set merchant table to identify updated merchant location data.

14. The method in accordance with claim 10, further comprising:
generating a job history record from the input file.

15. The method in accordance with claim 10, further comprising:
generating an input file history record from the input file.

16. The method in accordance with claim 10, further comprising:
generating a match history log record from the match load table.

17. The method in accordance with claim 16, further comprising:
generating a match history record from the match history log table, the match history record excluding any entry of the one or more entries that has an action code indicating the corresponding entry is one of a junk location, a bad entry, or a false positive location.

18. The method in accordance with claim 10, further comprising:
generating a response file from the match load table, the response file including the one or more entries of the input file and the appended corresponding transaction source type data.

19. A computer-implemented method for refreshing location data associated with merchants, which are received from a third-party aggregator, said method comprising:
retrieving a custom set merchant table from a memory device associated with an interchange network, the custom set merchant table including one or more entries, each entry having interchange network merchant location data contained therein;
determining a refresh frequency from a custom set table;
determining a refresh type from the custom set table;
based on the determined refresh frequency and refresh type, performing one or more refresh operations on the custom set merchant table to identify updated merchant location data; and
generating a custom set input file from the custom set merchant table and the updated merchant location data.

20. The method in accordance with claim 19 further comprising:
appending a comment to the one or more entries of the custom set merchant table indicating that the one or more entries were refreshed.

21. The method in accordance with claim 20, wherein appending the comment comprises appending the comment including identifying the refresh type performed.

22. The method in accordance with claim 19, wherein determining the refresh frequency comprises determining one of the following refresh frequencies: manual, weekly, monthly, quarterly, or yearly.

23. The method in accordance with claim 19, wherein retrieving a custom set merchant table comprises retrieving a plurality of custom sets, said method further comprising:
obtaining a list of set IDs corresponding to one or more of the plurality of custom sets that are due for the refresh operation in a predetermined period based on the determined refresh frequency of each custom set.

24. The method in accordance with claim 19, wherein performing the one or more refresh operations comprises comparing the custom set merchant table to a merchant location data table store in the memory device.

25. The method in accordance with claim 19, wherein determining the refresh type comprises determining one or more of the following refresh types: rolled location, new merchant ID, stale location, new aggregate location, and new M.I.A. matching location.
